(19) United States
(12) Patent Application Publication
(10) Pub. No.: US 2009/0248820 A1
(43) Pub. Date: Oct. 1, 2009

(54) INTERACTIVE UNIFIED ACCESS AND CONTROL OF MOBILE DEVICES

(76) Inventors: Otman A. Basir, Waterloo (CA); William Ben Miners, Guelph (CA)

Correspondence Address: CARLSON, GASKEY & OLDS, P.C., 400 WEST MAPLE ROAD, SUITE 350, BIRMINGHAM, MI, 48009, US

(21) Appl. No.: 12/411,265

(22) Filed: Mar. 25, 2009

Related U.S. Application Data
(60) Provisional application No. 61/039,242, filed on Mar. 25, 2008.

(51) Int. Cl. G06F 15/16; G10L 13/08

(52) U.S. Cl. 709/206; 704/260; 704/E13.002

(57) ABSTRACT

An interface between mobile devices and computing devices, such as a PC or an in-vehicle system permits a user to use the better user interface of the computing device to access and control the operation of the mobile device.

This application claims priority to U.S. Provisional Application Ser. No. 61/039,242, filed Mar. 25, 2008.

### BACKGROUND

Mobile email/contact/calendar devices, such as “smartphones,” wireless-enabled mobile devices, etc., (collectively referred to as “mobile devices”) are a convenient way for people to stay connected when traveling, in meetings and on the road. Email, contacts and calendar entries are cached on the mobile device and synced with a server via a wireless connection. Users can send and receive email, update contacts and add or changes calendar appointments, which updates are stored on the server. However, mobile devices have several limitations. The limited keyboard and display make it difficult to compose large emails or other documents. The mobile devices often cannot open all types of documents, especially larger or more complex documents.

### SUMMARY

The present invention provides an interface between mobile devices and computing devices, such as a PC or an in-vehicle system. The interface permits a user to use the better user interface of the computing device to access and control the operation of the mobile device.

In one feature of the present invention, large documents, such as email attachments, are not transmitted to the computing device entirely. Instead, the text of the document is first extracted by the mobile device (or by a server) and only the text is sent to the computing device. The text may then be presented to the user, either on a display or converted to speech and presented audibly.

In another feature, the mobile device changes modes in the presence of the computing device. For example, the mobile device may change call handling modes, such that it does not ring or vibrate for a new call, but instead notifies the computing device of the new call, so that the computing device can notify the user.

### BRIEF DESCRIPTION OF THE DRAWINGS

FIG. 1 illustrates a mobile device communicating with a laptop computing device using the interface of the present invention.

FIG. 2 illustrates the mobile device communicating with an in-vehicle computing system using the interface of the present invention.

FIG. 3 is a schematic of the interface of FIGS. 1 and 2.

### DESCRIPTION OF A PREFERRED EMBODIMENT

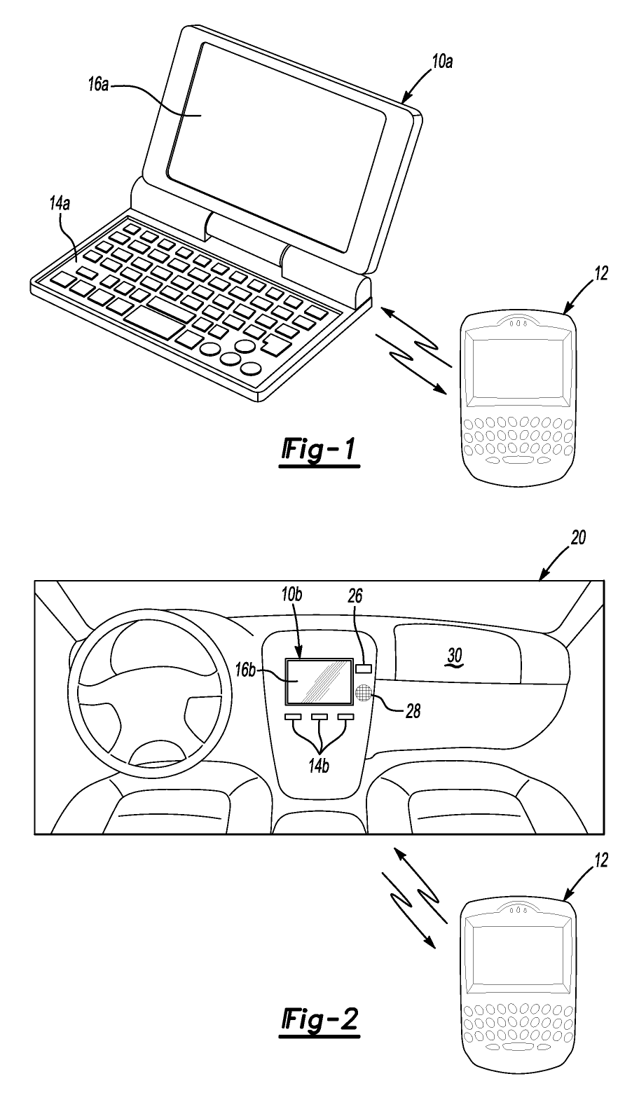

Referring to FIG. 1, a PC 10a includes a keyboard 14a and a display 16a that are much larger than those of a mobile device 12. The PC 10a is a general purpose computer with a processor, memory, storage (such as hard drive or other electronic, optical, magnetic or other mass storage). The PC 10a also typically has a more powerful processor and more memory and storage. Although a laptop or notebook computer is shown, the PC 10a could also be a desktop computer.

The mobile device 12 is a “smartphone” or mobile device with wireless connectivity. In this context, “mobile device” means a mobile device having at least a processor, local storage, local wireless connectivity (e.g. Bluetooth or similar) and wireless data connectivity via cell towers or satellite or some other wide area network. The mobile device 12 may also provide voice wireless connectivity (i.e. telephone functions) and may also include a display and user input device (such as telephone keys or a mini-keyboard or on-screen soft keys).

In the present invention, software is installed on the PC 10a and the mobile device 12 to communicate wirelessly (Bluetooth, WiFi, or other suitable protocol, preferably secure) with one another. Alternatively, or optionally, they can be connected via a wire, such as a USB cable, for increased speed and security. The mobile device software will connect with the PC software to provide the PC 10a real-time access to information on mobile device 12. It will also monitor mobile device activities and will alert the PC software of new email messages arriving on the mobile device 12, calendar events, sms, phone calls with (caller id), etc. The PC 10a software will provide a user interface to mobile device 12 contents and alerts through a user-friendly interface residing on the PC 10a. The user will be able to see a real-time image of mobile device 12 information content, including, emails: sent, received, sms, phone calls, etc.

For example, new emails arriving on mobile device 12 will show immediately on PC 10a software interface. The user can open the new emails using the PC 10a, along with previously-received emails that exist on the mobile device 12. The user can also open any attachments using PC 10 resident software (Microsoft Office, PowerPoint, Word, Acrobat, etc) to open and manipulate attachments. The user can respond to emails using the PC 10a and can attach documents from the PC 10a. The outcome of all activities are mirrored and executed in real-time on the mobile device 12 and as such the mobile device 12 will execute the responses as if it they were initiated on the mobile device 12. For instance, as soon as a new email arrives at the mobile device 12, a copy of the email is immediately presented on the PC 10a software. The user can open the email and attachments (if any), and reply to the email using the larger display and keyboard on the PC 10a, rather than the mobile device 12.

The PC 10a software will communicate the response of the user to the mobile device 12. The mobile device 12 in turn will send the response as if it was initiated from within the mobile device 12 using its wireless module, and logs it in its mailbox activities as a sent reply. Similarly, the user can initiate on the PC 10a software a new message to a recipient (new contact or a contact from the mobile device 12 contact list). The user can use PC 10a resident software applications to compose the message, and or attachments, and press send. The send command will cause the message to be communicated to the mobile device 12 which will send the email and log the message as a sent message on its mailbox file structure.

The user can also use the PC software to compose an sms message (or similar message format) to a person on the contact list and can also respond to sms messages. When a new call arrives on mobile device 12, the caller id is displayed on the display 16a of the PC 10a. The user can execute mobile device resident web browsers and use the larger display 16a for browsing the web.

With this invention, the PC 10a does not need to have internet connectivity or wifi connectivity to the internet. It just needs to have a wireless or a wired connection to the mobile device 12. The user can enjoy the mobile device 12 wireless connectivity and at the same time take advantage of the larger PC display 16a, keyboard 14a, and PC-resident software apps, without the need to pay for another wireless service for his/her PC 10a.

In a first mode of operation, the information on the mobile device 12 (contacts, calendar, emails, media files such as mp3s, mpegs, etc) is sent to the PC 10a as requested by the PC 10a for review by the user on the display 16a and/or modification with the keyboard 14a (and/or mouse or other user input devices). For example, the mobile device 12 sends a list of emails in the user's inbox when so requested by the PC 10a, and only after one of the emails has been selected by the user (via the user input devices on the PC 10a) is that email sent to the PC 10a. However, as the email is modified or forwarded or replied to by the user on the PC 10a, the modified email (or forward or reply) is transmitted to the mobile device 12 and is actually sent from the relevant program in the mobile device 12, such that for all intents, purposes and outward appearances, the email was sent by the mobile device 12.

In a second mode of operation, the PC 10a acts only as a “dumb” terminal for the mobile device 12. The PC 10a receives information to display on display 16a from mobile device 12, and the PC 10a sends user inputs from the keyboard 14a (or other user input devices) directly to the mobile device 12 to be processed by the processor of the mobile device 12. In this mode, the user's information is more secure, since none of it is stored on the PC 10a; however, the user does not gain the advantage of the increased processing power of the PC 10a. This would be appropriate when using a public PC 10a or someone else's PC 10a.

Preferably, the user can choose the first mode or the second mode with the mobile device 12, as appropriate in a given situation. When working on his own PC 10a, he can work in the first mode for increased power and speed, and when working on a PC 10a that is not his own he can work in the second mode for security (while still enjoying the improved interface with the larger display 16a and keyboard 14a or other user input devices).

In either mode, the access to the data on the mobile device 12 is in real-time. There is no need to wait for the devices to synchronize.

As shown in FIG. 2, the invention could also be implemented in a vehicle 20. The in-vehicle system 10b includes a display 16b (such as a touch-screen display), user input devices 14b (such as button, joysticks, etc). The in-vehicle system 10b may also include a microphone 26 and speaker 28 so that user speech recognition, user voice commands and speech feedback from the system 10b can be provided. In this manner, the user can access and control the mobile device 12 with the system 10b in the vehicle 20.

The mobile device 12 may automatically change modes based upon it detecting that it is in the presence of the system 10b (such as by detecting the wireless connection, e.g. Bluetooth, or when connected by a cable to the system 10b). In the presence of the system 10b, the mobile device 12 provides the information to the system 10b, provides notifications of new emails and other events to the system 10b, and the other functions described here. The mobile device 12 may also automatically change its ring and/or vibration behavior in the presence of the system 10b. For example, when connected to the system 10b, the mobile device 12 may no longer ring or vibrate for new incoming calls and emails, because notifications of the calls and emails will be provided by the system 10b.

The user can control the mobile device 12 with the user input devices 14b and view data from the mobile device 12 on the display 16b in a manner similar to that described above with respect to FIG. 1. Additionally, the user can give voice commands, which are processed by the system 10b and converted to commands to be sent to the mobile device 12. The user can further dictate emails or text messages to be sent by the mobile device 12 using the voice recognition of the system 10b. Additionally, the information from the mobile device 12 can be converted from text to speech and read to the user by the system 10b via the speaker 28. The system 10b can also be operated in either the first or second modes described above.

For example, emails received on the mobile device 12 are processed and converted to speech on the system 10b. The emails may be processed based upon a prioritization system, customized by the user and/or based upon the user's previous use history. The system 10b may present audible speech prompts asking the user if the user would like to hear a new email, also converting the sender's name to speech and the subject line of the email. If the user answers, “yes,” the system 10b converts the body of the email to speech and “reads” it to the user. The system 10b may then ask the user whether to reply, and if so, in what form (e.g. reply with speech to text, reply with an attached audio file, reply with a standard response, reply with a telephone call by indexing the user's contact list with the sender's email address).

If the email includes a large attachment that the user requests be converted to speech, there is no point in transmitting the entire large document to the system 10b. In that case, the mobile device 12 extracts the text from the attachment and transmits only the text to the system 10b in order to minimize latency and traffic over the connection. Similarly, if the document does not already exist on the mobile device 12, the mobile device 12 may request only the relevant text portions of that document from the server to minimize latency and traffic over the connection between the mobile device 12 and server. The size of the transmission can be substantially decreased for documents containing both text and pictures or graphics.

Even in some cases where it is intended to display the text on the display 16b, if only the text is required, only the text is transmitted to the system 10b. Again, this reduces the size of the transmission and latency in displaying the information.

Alternately, the mobile device 12 can deliver the request to one or more servers. The servers may be able to more efficiently access the requested information, process it based on the request, and return only the relevant information back to the mobile device 12. Responses are preprocessed based on remote system configuration, including the final presentation method used to deliver information to the user.

This function is not limited to email attachments, but could be used for any documents. The text could be extracted by the mobile device 12 or by the server from which the document is obtained, in order to reduce transmission time and latency.

Again, all of this functionality described with respect to the second embodiment could be provided in the first embodiment.

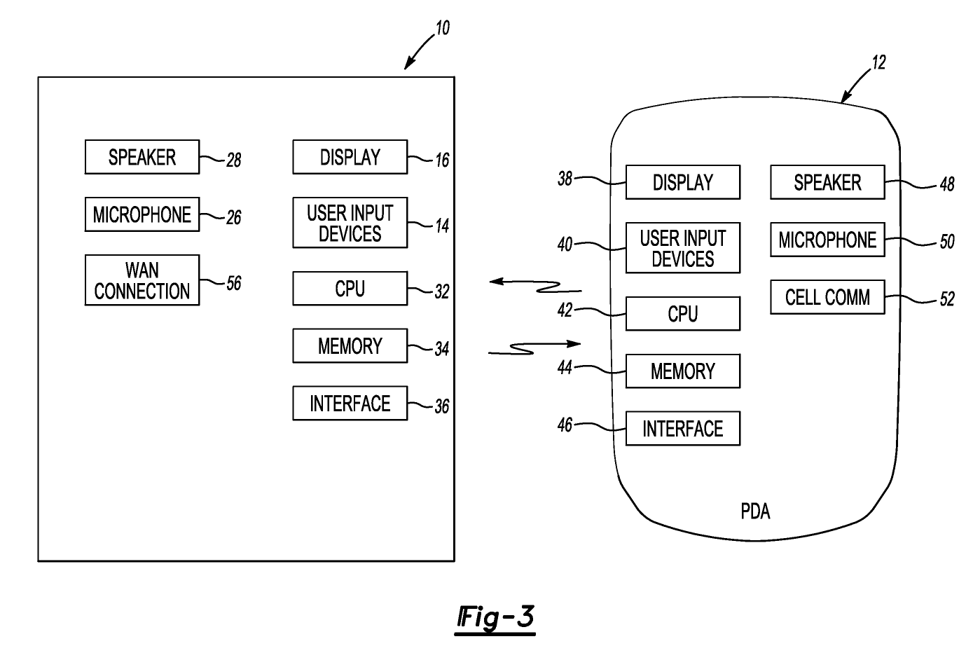

FIG. 3 schematically illustrates the components of the mobile device 12 and computing device 10 (generically referring to PC 10a or in-vehicle system 10b). The computing device 10 includes at least several of following components: the display 16, user input devices 14, speaker 28 and microphone 26 (the PC 10a could also include the speaker 28 and microphone 26, as they usually do, and could also include the speech recognition and text to speech capabilities described above). The computing device 10 includes a CPU 32, memory 34 and an interface 36 (such as a Bluetooth communication circuit and/or USB connector). The memory 34 stores computer instructions which when executed by the CPU 32 performs the functions described herein.

The mobile device 12 may include a display 38 and user input devices 40 (keys or keyboard, touchscreen, scroll wheels, etc). The mobile device 12 includes a CPU 42, memory 44 and interface 46 complementary to the interface 36 on the computing device 10. The mobile device 12 may include a speaker 48 and microphone 50 (such as for telephone applications) and includes a cellular communication circuit 52 (or satellite or other) for at least data transmission and preferably voice transmission. Contacts, calendar, tasks, email, media (music, video, books, audio, etc) are stored in memory 44. The memory 44 stores computer instructions which when executed by the CPU 42 performs the functions described herein.

In the first mode, software in memory 34 of the computing device 10 retrieves information from the memory 44 of the mobile device 12, stores it in memory 34 of computing device 10, from which it is displayed on the display 16 (and/or read or played over speaker 28) and can be modified with user input devices 14 (or microphone 26). The modified information may be sent back to the mobile device 12 for storage in memory 44 and/or retransmission (such as an email or meeting request, etc) by the mobile device 12.

In the second mode of operation, the computing device 10 acts only as a “dumb” terminal for the mobile device 12 via the interface 36. The computing device 10 receives information to display on display 16 (or read or play over speaker 28) from mobile device 12, and the computing device 10 sends user inputs from the keyboard 14 (or other user input devices) or converted speech commands directly to the mobile device 12 to be processed by the processor 42 of the mobile device 12. The processor 42 of the mobile device 12 acts on the information stored in its memory 44. In this mode, the user's information is more secure, since none of it is stored on the computing device 10; however, the user does not gain the advantage of the increased processing power of the computing device 10. This would be appropriate when using a public computing device 10 or someone else's computing device 10.

In either mode, the computing device 10 can also access telephone functions of the mobile device 12 (for mobile devices 12 with telephone functionality). For example, using the computing device 10, the user can access contacts stored in the mobile device 12 and choose a phone number, which is then dialed by the mobile device 12. The user can use the microphone 26 and speaker 28 of the computing device 10 to converse on the telephone call. Also, the mobile device 12 informs the computing device 10 of incoming telephone calls (with caller id information displayed on display 16 or read via speaker 28), incoming email or sms or text messages, etc.

The mobile device 12 can also make use of an internet connection 56 of the computing device 10, if the computing device internet connection is faster than that of the mobile device 12.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A method of accessing information via a mobile device including the steps of:
a) establishing a connection with the mobile device;
b) receiving text of an email from the mobile device via the connection;
c) detecting the presence of an attachment to the email;
d) requesting extracted text of the attachment; and
e) receiving the extracted text of the attachment.

2. The method of claim 1 further including the step of modifying the information on the mobile device.

3. The method of claim 1 further including the step of:
f) extracting the extracted text from the attachment in response to said step d).

4. The method of claim 3 wherein said step f) is performed by the mobile device.

5. The method of claim 1 further including the step of converting the extracted text to audible speech and presenting that audible speech audibly.

6. The method of claim 1 wherein the extracted text of the attachment is received via the connection.

7. A computer readable medium storing a computer program which when executed by a processor performs the steps of:
a) receiving an email including a message and an attachment;
b) receiving a request for the email;
c) transmitting the message of the email in response to said step b);
d) extracting text from the attachment; and
e) transmitting the extracted text from the attachment.

8. The computer readable medium of claim 7 wherein the computer program, when executed by a processor, further performs the steps of:
f) receiving a request for extracted text of the attachment; and
wherein said step e) is performed in response to said step d).

9. A mobile device comprising:
a processor; and
a computer readable medium storing instructions, which when executed by the processor, extracts text from an attachment to an email and transmits the extracted text in response to a request from a computing device having a connection to the mobile device.

10. The mobile device of claim 9 wherein the mobile device changes modes upon detection of the presence of the computing device, wherein changing modes includes changing call handling features.

11. The mobile device of claim 10 wherein changing call handling features includes changing ring and/or vibrating responses to incoming calls or emails.

12. A method of operating a mobile device including the steps of:
a) establishing a connection with a computing device;
b) detecting the presence of the computing device based upon the connection;
c) changing call handling modes based upon said step b).

13. The method of claim 12 wherein said step c) further includes the step of disabling ringing for incoming calls in response to said step b).

14. The method of claim 12 further including the step of returning the call handling mode based up no longer detecting the presence of the computer device.
